(19) United States
(12) Patent Application Publication
(10) Pub. No.: US 2015/0229160 A1
(43) Pub. Date: Aug. 13, 2015

(54) POWER FAILURE PREVENTION SYSTEM AND CIRCUITS

(71) Applicants: Panasonic Asia Pacific Pte. Ltd., Singapore (SG); PANASONIC CORPORATION, Osaka (JP)

(72) Inventors: Yoshihito KAWAKAMI, Osaka (JP); Takuya ISHII, Osaka (JP); Hong Meng TANG, Singapore (SG); Chung Kiong Leslie KHOO, Singapore (SG); Tien Yew KANG, Singapore (SG); Jiong FU, Singapore (SG)

(73) Assignees: PANASONIC ASIA PACIFIC PTE. LTD., Singapore (SG); PANASONIC CORPORATION, Osaka (JP)

(21) Appl. No.: 14/174,972

(22) Filed: Feb. 7, 2014

(51) Int. Cl. H02J 9/06; H02M 3/07; H02M 3/156

(52) U.S. Cl. CPC H02J 9/061; H02M 3/156; H02M 3/07

(57) ABSTRACT

A DC-DC converter system that can switch between BOOST and BUCK operation is used in a power failure prevention system. The DC-DC converter operates in BOOST mode at startup. It charges a storage capacitor via an inductor having its peak current controlled, together with a soft start ramp to limit the power supply in-rush current. During power failure, if the storage capacitor is charged above a pre-determined threshold and the input power supply discharges below a programmable threshold, the DC-DC converter switches from BOOST to BUCK mode, detectable through an internal power detection circuit; its output may also control an external/internal power switch that isolate the input main supply from the power bus. The BUCK mode converter will then dump the charges from the storage capacitor back to the power bus. The BOOST to BUCK mode seamless switchover is achieved through an analog/digital multiplexer that simplify the circuit implementation.

### BACKGROUND OF THE INVENTION

In typical storage systems such as solid state drives or hard disk drives, it is important that the power supply do not have sudden fault such as power dip or power failure. In the event that such power failure occurs, the storage system will need to perform data backup. This is to prevent any loss of data information during this power failure period. Power failure detection circuit therefore becomes important in this type of system.

FIG. 1 and FIG. 2 show a conventional power failure detection circuit of a prior art. System circuitries 2 consist of a Power Detector 1, PUMP Circuit 6 and DUMP Circuit 7 that form the power failure detection circuit. Firstly, it is necessary to detect the power input level, P_{VIN} using a power detector 1. This power detector 1 can be in the form of a comparator, comparing the power input level, P_{VIN} with a fix known reference level, V_{REF}. FIG. 1 shows the conventional diagram when power supply level is still high. During this time, the comparator in the power detector 1 will see power supply P_{VIN} higher than the reference voltage V_{REF}. It will thereby output a logic Low level at node SW 3 causing the PUMP Circuit 6 to start operating. The PUMP circuit 6, which can be a charge pump that charges the storage capacitor 5 C_{VSTG} to a multiple of P_{VIN} level. Storage capacitor 5, C_{VSTG} stores up charges during this time getting ready to dump these charges in the event of a power failure.

FIG. 2 shows the conventional diagram when power supply failure occurs for the same prior art. During this time, comparator in the power detector 1 will see power supply PVIN lower than reference voltage V_{REF}. It will thereby output a logic High level at node SW 3 causing the PUMP Circuit 6 to be powered off and the DUMP Circuit 7 to start operating. As a result of the DUMP Circuit operation, storage capacitor 5 C_{VSTG} starts to discharge and dump its charges into the system circuitries 2. These charges in storage capacitor 5 C_{VSTG} will act as the temporary power supply P_{VOUT} for the system circuitries 2, allowing it to perform critical back up of its data to prevent data loss. This back up will last for a short duration depending on the storage capacitor 5 C_{VSTG} size as well as the input power supply level P_{VIN}. The larger the C_{VSTG} and higher the input power supply level P_{VIN} allows a longer back up timing.

There are a few disadvantages to this type of conventional way of detecting power supply failure. Firstly, the storage capacitor 5 C_{VSTG} needs to be of a very large value so as to prolong the back-up timing. This is especially so when detection input level is very low. With the large capacitor, this will in turn result in higher system component cost as well as larger printed circuit board design space which are undesirable when it comes to product design.

Secondly, back-up timing sustained by the storage capacitor 5 C_{VSTG} will vary when input detection level of P_{VIN} is varied. When power failure detection level is of the lowest, this will result in the shortest back-up timing for the system. Therefore, it is necessary to change the storage capacitor 5 C_{VSTG} value under different power failure detection voltage to be designed. This makes design lead time longer and causes system component inventory to be difficult to be managed since changing power failure detection level will result in changing another hardware component for storage capacitor 5 C_{VSTG}.

Thirdly, the backup charge from the storage capacitor 5 could back flow to the failure power supply. Depending on the type of power failure, the back-up timing could be greatly impact due to additional leakage path to the failure power source. Furthermore, without isolation of the failure power source, the logic output of power detector 1 could become erratic if PVIN node has too much noise.

### SUMMARY OF THE INVENTION

According to the present invention, a power failure prevention system according to a first embodiment comprising:

a supply voltage source;

a voltage output;

a charge-pump controller, serving as a charge pump under normal conditions, and to stop operation when the supply voltage level drops below a predetermined level;

a switch, controlling the electrical connection between a supply voltage source and a voltage output, to close under normal conditions and to open when the supply voltage level drops below a predetermined level;

a charge storage capacitor, coupled to said charge pump controller and a dump controller;

an input supply capacitor, coupled to said supply voltage source;

an output capacitor, coupled to said voltage output;

a pump capacitor, coupled to said charge pump controller, together serves as a charge pump to generate up to two times the voltage level of said supply voltage source across said charge storage capacitor; and

a dump controller, coupled to said voltage output, directing the energy from charge storage capacitor to said voltage output, when the supply voltage level drops below a predetermined level, thus maintaining the voltage output level to almost equal to initial voltage level of said supply voltage source.

The summary described herein is merely describing one embodiment of a plurality of embodiments as will be described in the ‘DETAILED DESCRIPTION OF THE PREFERRED EMBODIMENTS’.

### BRIEF DESCRIPTION OF THE DRAWINGS

FIG. 1 shows a conventional power failure detection circuit during storage capacitor charging according to the prior art;

FIG. 2 shows a conventional power failure detection circuit during storage capacitor discharging according to the prior art;

FIG. 3A shows the first embodiment of a power failure prevention system using a Charge-Pump and Dump controller.

FIG. 3B shows a detail of the dump controller used in the circuit of FIG. 3A.

FIG. 4A shows the second embodiment of a power failure prevention system using a BOOST and BUCK controller.

FIG. 4B shows a detail of the buck controller used in the circuit of FIG. 4A.

FIG. 5 shows the third embodiment of a power failure prevention system using a single DC-DC converter that can operate in BOOST and BUCK mode.

FIG. 6 shows the detailed circuit diagram implementation of a power failure prevention system using a buck-boost converter during storage capacitor charging according to one embodiment of the present invention.

FIG. 7 shows the detailed circuit diagram implementation of a power failure prevention system using a buck-boost converter during storage capacitor discharging according to one embodiment of the present invention.

It will be recognized that some or all of the Figures are schematic representations for purposes of illustration and do not necessarily depict the actual relative sizes or locations of the elements shown.

### DETAILED DESCRIPTION OF THE PREFERRED EMBODIMENTS

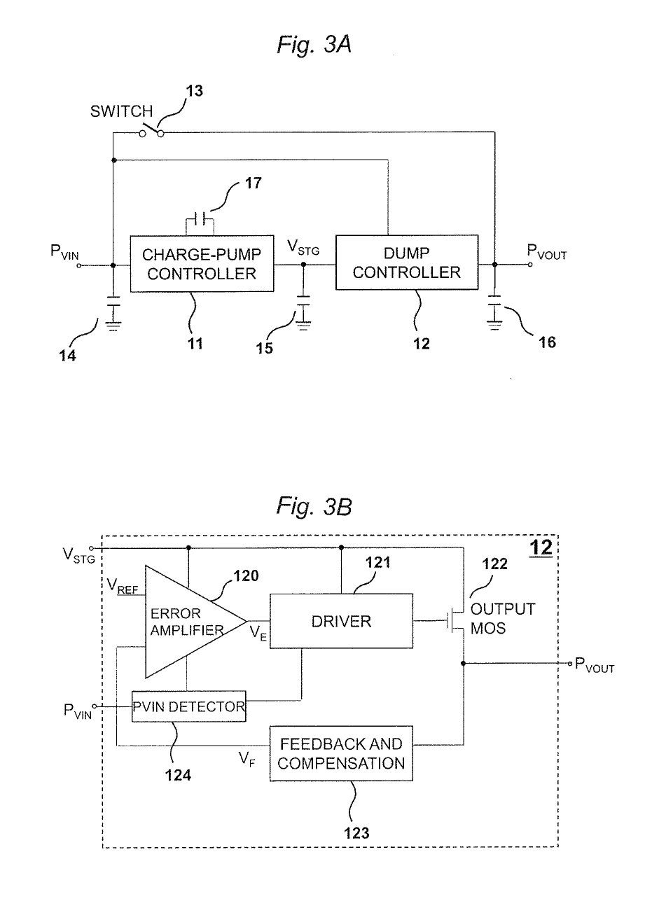

Referring to FIG. 3A, a first embodiment of a power failure prevention system according to the present invention is shown.

The first embodiment has a charge-pump controller 11, a dump controller 12, a switch 13, an input supply capacitor 14, a charge storage capacitor 15, an output capacitor 16 and a pump capacitor 17.

In normal operation, a supply voltage source is connected at P_{VIN}. When the P_{VIN} voltage source level has increased to an appropriate voltage level, the switch 13 is closed in order to direct the voltage supply from P_{VIN} to P_{VOUT}. The P_{VOUT} is the output voltage source for other subsequent circuits. At the same time, the charge storage operation is initiated and the dump controller 12 is in off condition. The charge-pump controller 11 is slowly storing or charging the charge storage capacitor 15 by using the power from P_{VIN}. Firstly, the pump capacitor 17 can be charged to almost equivalent or partial of P_{VIN} voltage. Then the charge in the pump capacitor 17 is being transferred or pumped to the charge storage capacitor 15. Generally, the charge storage capacitor 15 is much bigger than the pump capacitor 17. The charge storage capacitor 15 is normally in high capacitance and arranged with multiple pieces as parallel. Hence, the charge-pump controller 11 has to repeat this charging and pumping operation continuously until a predetermined V_{STG} voltage is reached. The maximum voltage level which can be charged and stored in charge storage capacitor 15 is about 2 times the P_{VIN} voltage level. If by combining more than 1 stage of pump capacitor 17, it is possible for the storage voltage to achieve more than 2 times the P_{VIN} voltage. When the pre-determined V_{STG} is reached, the charging operation frequency may be reduced in order to avoid switching loss of charge-pump controller 11. The energy which can be stored in the charge capacitor 15 is based on formula,

E=½×C×V_{STG}²,

where C is the capacitance of the charge storage capacitor 15.

Generally in order to maximize the backup storage energy, either the value of the capacitance or V_{STG} has to be increased.

The next event of operation is the backup charge dumping operation due to the P_{VIN} supply being reduced or disconnected. When the P_{VIN} voltage drops to a predetermined voltage level, the switch 13 is opened and charge-pump controller 11 stops operation. Then the dump controller 12 starts operation by directing the backup energy from charge storage capacitor 15 to the P_{VOUT}. The energy of charge storage capacitor 15 is slowly being discharged or reduced due to the energy consumption of subsequent circuits which connected to P_{VOUT}. The backup energy can only be sustained for a limited time period depending on the power consumption at P_{VOUT}. The dump controller 12 always maintains the P_{VOUT} voltage level almost similar to previous P_{VIN} voltage level, as long as the V_{STG} voltage level is higher than previous P_{VIN} voltage level. The dump controller 12 is usually a linear regulator or LDO which can regulate P_{VOUT} at a constant voltage level. The dump controller 12 must be able to withstand the higher voltage input at V_{STG}. Normally after the V_{STG} voltage has been discharged lower than previous PVIN voltage level, the dump controller 12 enters into under-voltage protection mode.

In the under-voltage protection mode, dump controller 12 turns off P_{VOUT}, effectively bringing P_{VOUT} to ground.

Referring to FIG. 3B, an exemplary implementation of a dump controller 12 is generally a linear regulator or LDO. It consists of an error amplifier 120, a driver 121, an output MOS 122, a feedback and compensation block 123 and a P_{VIN} detector 124. The function of this dump controller 12 is to provide a low noise constant stable P_{VOUT} voltage independent of input voltage variations and load variations. When P_{VIN} voltage is reducing or disconnected, the P_{VIN} detector 124 will enable the error amplifier 120 and driver 121. The error amplifier 120 receives the differential signal between a reference voltage V_{REF} and feedback signal V_{F} to generate the V_{E} signal. Reference voltage V_{REF} may be internally generated or obtained from an external source. The feedback and compensation block 123 provides the feedback signal V_{F} with reference to P_{VOUT} voltage condition. Based on the V_{REF} and V_{F} signals, the error amplifier 120 controls the output MOS 122 through the driver 121 in order to consistently regulate the P_{VOUT} voltage even if V_{STG} voltage is in discharging condition. The P_{VOUT} capacitor 16 and feedback and compensation circuit 123 maintain the stability of the regulator with sufficient phase and gain margin. The regulation continues until under-voltage is detected on VSTG.

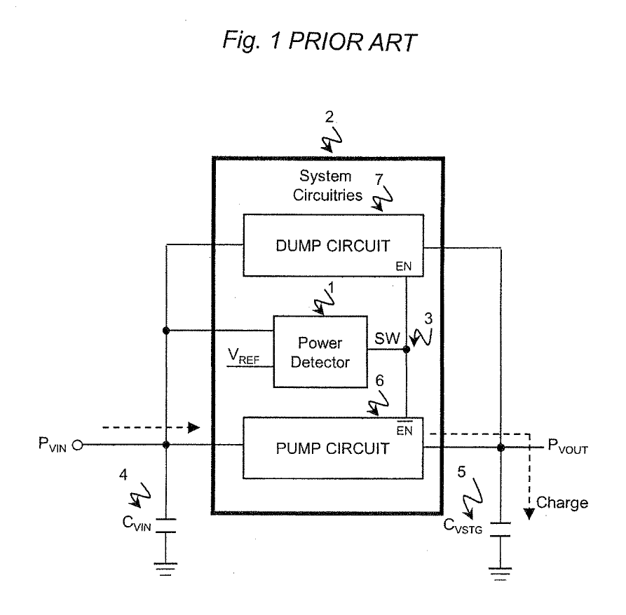

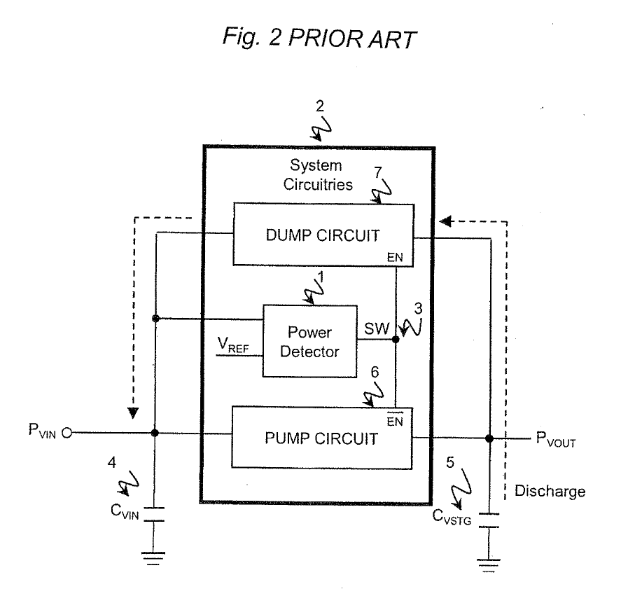

The said first embodiment has an advantage over the prior art in FIG. 1, such that the dumping operation is controlled through switch 13. Switch 13 can be a MOS switch with a back to back body diode. During dumping, the current is prevented from back flowing into P_{VIN}. This improves the dumping period as the back flow leakage current is prevented. In worst case event that P_{VIN} is shorted to ground, the absence of switch 13 greatly reduces the storage energy required for backup purpose.

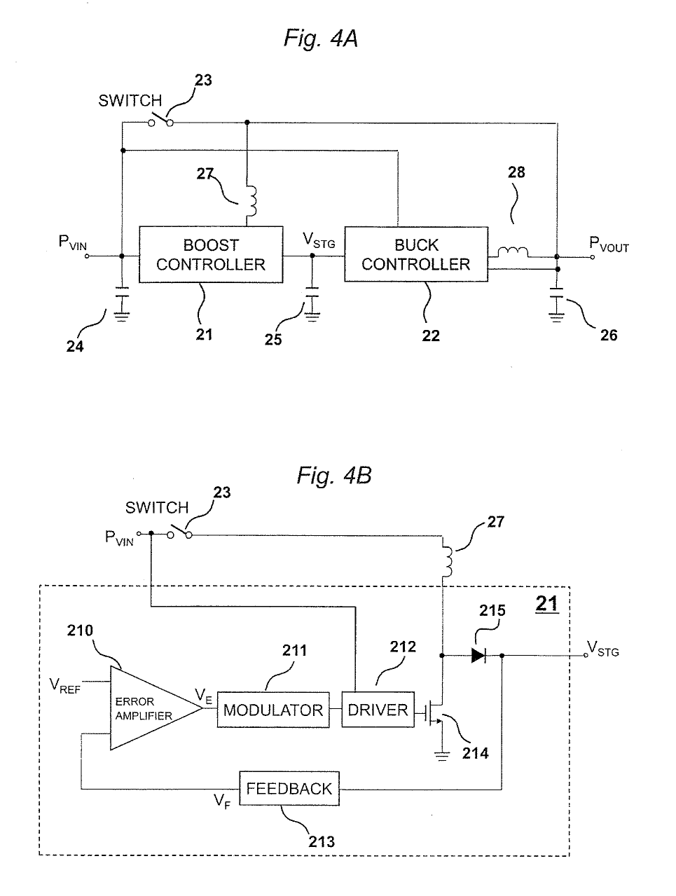

Referring to FIG. 4A, a second embodiment of a power failure prevention system according to the present invention is shown.

The second embodiment has a boost controller 21, a buck controller 22, a switch 23, an input supply capacitor 24, a charge storage capacitor 25, an output capacitor 26, a boost inductor 27 and a buck inductor 28.

Similar to the first embodiment, at normal operation, a supply voltage source is connected at P_{VIN}. When the P_{VIN} voltage source level has increased to an appropriate voltage level, the switch 23 is closed in order to direct the voltage supply from P_{VIN} to P_{VOUT}. The P_{VOUT} has now become the main voltage source for other subsequent circuits. At the same time, the charge storage operation is initiated and the buck controller 22 is in off condition. The boost controller 21 is slowly storing or charging the charge storage capacitor 25 by using the power from P_{VIN} after switch 23. Firstly, the boost inductor 27 is energized by allowing current flow through it for certain time period. Then this inductive current is diverted to charge the charge storage capacitor 25 which is normally in high capacitance and arranged with multiple pieces as parallel. The boost controller 21 has to repeat energizing boost inductor 27 and charging the charge storage capacitor 25 operations continuously until a pre-determined V_{STG} voltage is reached. By using only one boost inductor 27 and boost controller 21, the V_{STG} backup storage voltage which is much higher than P_{VIN} voltage level can be achieved. When the predetermined V_{STG} is reached, the boost controller 21 is able to change from continuous switching mode to power saving mode. The energy which can be stored in the charge capacitor 25 is based on formula,

E=½×C×V_{STG}²,

where C is the capacitance of the charge storage capacitor 25.

Generally in order to maximize the backup storage energy, either capacitance or V_{STG} has to be increased.

The next event or operation is the backup charge dumping operation due to the P_{VIN} supply being reduced or disconnected. When the P_{VIN} voltage drops to a predetermined voltage level, the switch 23 is opened and boost controller 21 stops operation. The buck controller 22 starts operation by directing the backup energy from charge storage capacitor 25 to the P_{VOUT}. The energy of charge storage capacitor 25 is slowly being discharged or reduced due to the energy consumption of subsequent circuits which are connected to P_{VOUT}. The backup energy can only be sustained for a limited time period depending on the power consumption at P_{VOUT}. As long as the V_{STG} voltage level is higher than previous P_{VIN} voltage level, buck controller 22 always maintains the P_{VOUT} voltage level almost similar to previous P_{VIN} voltage level. In order to maintain the P_{VOUT} voltage at a constant level, the buck controller 22 controls the energizing and de-energizing time period for buck inductor 28 based on the feedback information from P_{VOUT}. Comparing to linear regulator, buck controller 22 has higher efficiency. Hence, the backup charge dumping time period can be extended for the same amount of energy stored in charge capacitor 25. The buck controller 22 must be able to withstand the higher voltage input at V_{STG}. Normally after the V_{STG} voltage has been discharged lower than previous P_{VIN} voltage level, the buck controller 22 enters into under-voltage protection mode.

In the under-voltage protection mode, buck controller 22 turns off P_{VOUT}, effectively bringing P_{VOUT} to ground.

Referring to FIG. 4B, an exemplary embodiment of a boost controller 21 is generally a dc switching converter. It consists of an error amplifier 210, a modulator 211, a driver 212, a feedback block 213, a low side output MOS 214 and an output diode 215. The boost controller 21 is to generate a higher voltage on V_{STG} based on a lower voltage source of P_{VIN}. The feedback block 213 generates V_{F} signal based on V_{STG}. The error amplifier 210 generates V_{E} signal based on the difference between reference voltage V_{REF} and V_{F}. Reference voltage V_{REF} may be internally generated or obtained from an external source. By using the V_{E} signal, the modulator 211 is able to activate or deactivate the output MOS 214 through the driver 212. Initially during P_{VIN} is just applied, V_{STG} is generally at very low voltage. So the error amplifier 210 generates higher V_{E} based on the big difference between V_{REF} and V_{F}. The modulator 211 receives higher V_{E} signal which is to activate output MOS 214 more frequently. During output MOS 214 is turned on, current is being ramped up in inductor 27 and causing it being energized. After output MOS 214 is being turned off, the current in inductor 27 need to continue to flow and it will flow through output diode 215 and charge up capacitor 25. So the voltage on capacitor 25 is continuously being charged up by the current of inductor 27. The output MOS 214 switching operation by modulator 211 continues until V_{STG} reaches the predetermined voltage level which is the V_{F} voltage reaches V_{REF} voltage level. It is possible to make the modulator 211 stop switching operation when V_{STG} voltage level can be kept at predetermined voltage level. When the PVIN has been disconnected or reduced, the switching operation stops and the output MOS 214 is being turned off in order to keep the high voltage charge in output capacitor 25.

Embodiment 2 not only share the same advantage as Embodiment 1 over prior art in FIG. 1, it uses a boost converter that achieves higher and more reliable storage voltage.

Firstly, charge pump can only achieve 2 times the P_{VIN} voltage if a single capacitor element is used. Boost converter on the other hand can achieve higher storage voltage, using a single inductor element. A higher storage voltage significantly reduces the amount of storage capacitance needed during backup as capacitor storage energy is a squared function of its storage voltage.

Secondly, the output voltage of such boost converter can be made independent of its input supply variation. Charge pump derives it storage voltage from P_{VIN}, its storage energy reduces in square function with its input supply voltage. This relationship further differentiates the usefulness of Embodiment 2.

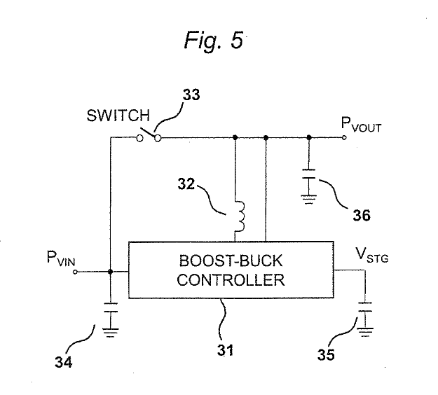

Referring to FIG. 5, a third embodiment of a power failure prevention system according to the present invention is shown.

The third embodiment has a boost-buck controller 31, an output inductor 32, a switch 33, an input supply capacitor 34, a charge storage capacitor 35 and an output capacitor 36.

Similar to the first and second embodiments, a supply voltage source is connected at P_{VIN}. When the P_{VIN} voltage source level has increased to an appropriate voltage level, the switch 33 is closed, in order to direct the voltage supply from P_{VIN} to P_{VOUT}. The P_{VOUT} has now become the main voltage source for other subsequent circuits. At the same time, the boost-buck controller 31 is in the boost DC-DC converter mode (hereinafter referred to as ‘boost mode’) and the charge storage operation is initiated. The boost-buck controller 31 is slowly storing or charging the charge storage capacitor 35 by using the power from P_{VIN} via switch 33. Firstly, the output inductor 32 is energized by allowing current flow through it for a certain time period. Then this inductive current is diverted to charge the charge storage capacitor 35 which is normally of high capacitance value and arranged with multiple pieces in parallel. The boost-buck controller 31 has to repeatedly energize the output inductor 32 and charge the charge storage capacitor 35 continuously until a pre-determined V_{STG} voltage is reached. By using only one output inductor 32 and boost-buck controller 31, the V_{STG} backup storage voltage which is much higher than P_{VIN} voltage level can be achieved. When the pre-determined V_{STG} is reached, the boost-buck controller 31 is able to change from continuous switching mode to power saving mode. The energy which can be stored in the charge storage capacitor 35 is based on formula,

E=½×C×V_{STG}²,

where C is the capacitance of the charge storage capacitor 35.

Generally in order to maximize to backup storage energy, either capacitance or V_{STG} have to be increased.

The next event or operation is the backup charge dumping operation due to the P_{VIN} supply being reduced or disconnected. When the P_{VIN} voltage drops to a predetermined voltage level, the switch 33 is opened and boost-buck controller 31 changes operation from boost mode to the buck DC-DC converter mode (hereinafter referred to as ‘buck mode’). Buck mode directs the backup energy from charge storage capacitor 35 to the P_{VOUT}. The energy of charge storage capacitor 35 is slowly being discharged or reduced due to the energy consumption of subsequent circuits connected to P_{VOUT}. The backup energy can only be sustained for a limited time period depending on the power consumption at P_{VOUT}. The boost-buck controller 31 always maintains the P_{VOUT} voltage level almost similar to previous P_{VIN} voltage level, as long as the V_{STG} voltage level is higher than previous P_{VIN} voltage level. In order to maintain the P_{VOUT} voltage at a constant level, the boost-buck controller 31 controls the energizing and de-energizing time period for output inductor 32 based on the feedback information from P_{VOUT}.

Similarly, the boost-buck controller 31 must be able to withstand the higher voltage input at V_{STG}. Normally after the V_{ST}G voltage has been discharged lower than previous P_{VIN} voltage level, the boost-buck controller 31 enters into under-voltage protection mode.

In the under-voltage protection mode, boost-buck controller 31 turns off P_{VOUT}, effectively bringing P_{VOUT} to ground.

Compared with the second embodiment, the third embodiment is much more compact and simple.

Firstly, the original two controllers have been integrated as one boost-buck controller; many similar circuit functions can be shared through novel circuit implementation. This greatly reduces the amount of silicon area required and thereby lowers the cost of the product.

Secondly, apart from just requiring a single inductor element, the highly integrated boost-buck controller reduces the package pin out and thereby reduces the external BOM. It simplifies customer application with less external components to consider and also reduces PCB area requirement.

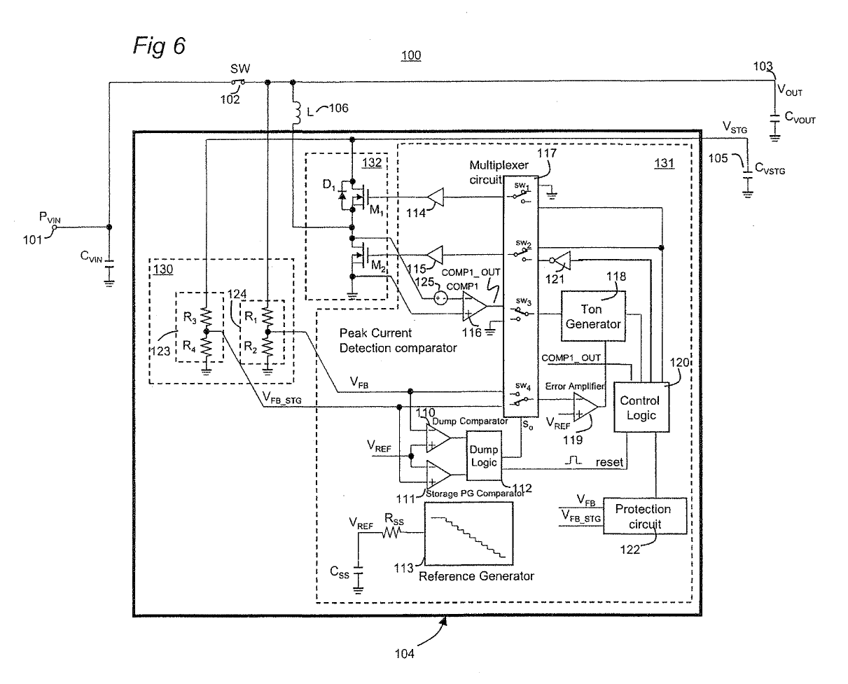

In FIG. 6, an exemplary implementation of the third embodiment using a buck-boost converter is shown. Power Failure Prevention System 100 comprises an energy storage capacitor 105, a voltage input node 101, a load switch 102, a voltage output node 103, an inductor 106 and a buck-boost DC-DC controller system 104. Buck-boost DC-DC controller system 104 further comprises of feedback block 130, buck-boost DC-DC controller circuit 131 and power switch block 132.

The voltage input node 101 is connected to the primary power supply P_{VIN} during the charge storage operation. The load switch 102 is connected between the voltage input node 101 and voltage output node 103. The load switch may conduct in BOOST mode and may open in BUCK mode. The voltage output node 103 is connected to the output of buck-boost DC-DC controller system 104 though inductor 106. The voltage output node 103 may supply a regulated voltage to the electronic device in BUCK mode.

An exemplary implementation of feedback block 130 comprises of voltage divider 124 formed by resistors R1 and R2, configured to monitor the voltage input node 101, and a voltage divider 123 formed by resistors R3 and R4, configured to monitor the voltage of an energy storage capacitor 105. The input voltage P_{VIN} is divided down by the resistor divider 124 to a voltage V_{FB}, which functions as a feedback to the buck-boost DC-DC controller circuit 131. The voltage V_{STG} is divided down by the resistor divider 123 to a voltage V_{FB}_{_{—}}_{STG}, which functions as a feedback to the buck-boost DC-DC controller circuit 131. The buck-boost DC-DC controller circuit 131 shall use the V_{FB} and V_{FB}_{_{—}}_{STG} voltage level to determine the DC-DC operation mode. The V_{FB} is connected to a Dump comparator 110, which compares V_{FB} with a reference voltage V_{REF}. The V_{FB}_{_{—}}_{STG} is connected to a Storage PG comparator 111, which compares V_{FB}_{_{—}}_{STG} with a reference voltage V_{REF}. The output of the Dump comparator 110 and Storage PG comparator 111 are coupled to dump logic 112, which determines the Power Failure Prevention System 100 to operate in BOOST mode or BUCK mode.

An alternative implementation of the third embodiment would be that the input voltage P_{VIN} may be used directly without resistor divider 124.

The buck-boost DC-DC controller circuit 131 further comprises pre-drivers 114 and 115, which are connected to the gate of the low-side power switch M2 and high-side power switch M1 respectively, of said power switch block 132.

Peak current detection comparator 116 with a pre-determined offset voltage 125 at its inverting input terminal compares the voltage across the drain and source terminals of the low-side power switch and outputs an over-current limit signal and zero-current detection signal to control logic 120 via COMP1_OUT, thus providing the over-current protection and skip mode control for the buck-boost DC-DC controller circuit 131. COMP1_OUT is the output node of Peak current detection comparator 116. The polarity and the location of the offset voltage 125 is not limited only to the diagram shown, its polarity could be reversed and it can also be inserted at the non-inverting input terminal of the comparator

Reference generator 113 is connected to soft-start capacitor Css and soft-start resistor Rss. The soft-start capacitor Css, soft-start resistor Rss and reference generator 113 determine the soft-start time of the buck-boost DC-DC circuit 131 in BOOST mode, such that the input rush current in BOOST mode can be limited to a known level. In an alternative exemplary implementation, the soft-start capacitor Css and soft-start resistor R_{SS} is excluded.

Multiplexer circuit 117, that acts as the operation mode switch between BOOST to BUCK modes, comprises of a combination of analog and digital multiplexers that connect between one or more analog nodes or logic input & output. The Multiplexer circuit 117 accepts a logic input Sₒ, that decides the switch connection of sw1, sw2, sw3 & sw4. The comparator logic combination from dump logic 112 is connected to Sₒ.

The default switch position for sw1, sw2, sw3 & sw4 is as shown in FIG. 6 when the system is operating in BOOST mode. During BOOST mode, sw1 connects pre-driver 114 input to ground and keep high-side power switch M1 always off. Switch sw2 connects pre-driver 115 to control logic 120, which decides the turn on duration of the low-side power switch M2, based on input from Ton Generator 118. The control logic 120 shall generate pulse width modulated signals that keeps the system switching frequency constant during BUCK mode and the inductor current constant or clamped during BOOST mode. In this embodiment, sw3 connects the Peak current detect comparator 116 to the Ton Generator 118, such that during BOOST mode the Ton pulse width, generated by control logic 120, is controlled to ensure that inductor peak current is clamped or constant. The system relies on one single error amplifier 119 for voltage regulation. Switch sw4 connects the inverting input of error amplifier 119 to the resistor feedback of V_{STG} during BOOST mode. The error amplifier 119 output is connected to Ton generator 118, which in turn signals to the Control Logic 120 to trigger the next Ton pulse.

During the initial startup, SW 102 is closed, connecting P_{VIN} to the inductor 106 at node 103. The output from dump logic 112 is reset to BOOST mode when P_{VIN} is connected. The Reference Generator 113 will initiate a soft start slope to the non-inverting input of Error Amplifier 119. When V_{FB}_{_{—}}_{STG} is lower than the V_{REF}, the Error amplifier 119 output will change its logic state and signals to the Ton generator 118 to further signal to Control Logic 120 to trigger a Ton logic pulse width. The low-side power switch M2 will turn on and inductor 106 will be charged from P_{VIN} through SW 102. If the Peak Current Detect comparator 116 detects that the inductor current reaches a pre-determined threshold, the Ton pulse width is shortened and power switch M2 will be turned off. The inductor current will continue to flow to body diode D1 of power switch M1 and cause the capacitor 105 C_{VSTG} to be charged up. Each time V_{FB}_{_{—}}_{STG} goes below V_{REF}, the above BOOST charging operation is repeated. The operation of the BOOST charging is not only limited to discontinuous conduction mode; the inductor current is discharged to zero before next cycle, It could also operate in continuous conduction mode such that inductor current is clamped by the current detect comparator 116. Such continuous conduction mode allows faster charging of the output capacitor. During BOOST mode operation, V_{STG} is regulated to a voltage level defined as:

V_{STG}=V_{REF}×(R3+R4)/R4

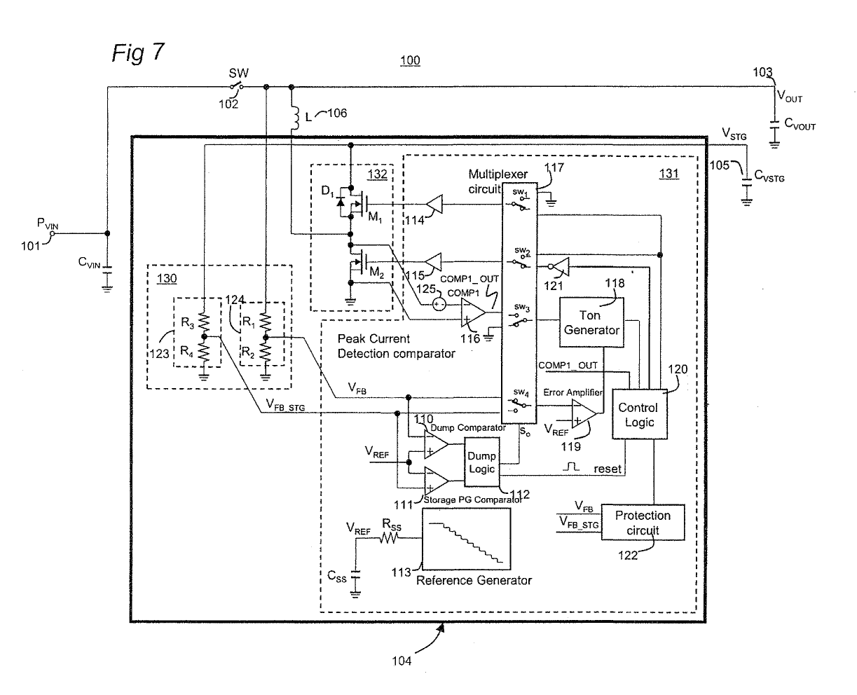

FIG. 7 shows the detailed implementation of the power failure prevention system during BUCK mode. Switch sw1 connects pre-driver 114 input to control logic 120 which decides the turn on duration of the high-side power switch M1. Switch sw2 connects pre-driver 115 to the inverted logic output of control logic 120 via inverter 121, effectively turning on power switch M2 after power switch M1 is turned off. Both power switches M1 and M2 turns on alternately during BUCK mode. In an alternative embodiment, the on/off sequencing of power switches M1 and M2 could be controlled through the pre-driver 114 and 115, such that no shot through will occur.

Switch sw3 disconnects the Peak current detect comparator output COMP1_OUT to the Ton Generator 118, and the system now operates in constant frequency during BUCK mode.

Switch sw4 connects the inverting input of the error amplifier 119 to the resistor feedback of P_{VIN}, The error amplifier 119 output is connected to the Control Logic 120 via Ton generator 118, that will determine when to trigger the next Ton pulse.

At normal startup, V_{STG} will be regulated to the voltage threshold defined by the voltage divider 123. Storage PG Comparator 111, determines if the V_{STG} voltage charges above a predetermined threshold. Dump Comparator 110 determines if the P_{VIN} voltage drops below a certain threshold through resistor divider 124. In event of P_{VIN} failure such as voltage being too low for proper circuit operation, disconnected or short circuit, DUMP Comparator 110 will be able to detect the failure condition as P_{VIN} voltage will drop to a certain threshold. If V_{STG} has already charged above the Storage PG comparator 111 threshold, the system will enter BUCK mode. The switch SW 102 will be opened and the buck-boost DC-DC controller system 104 disconnected from the P_{VIN} supply. The output from dump logic 112 is set to BUCK mode. At the same time, it will send a one shot reset pulse to the control logic 120 to reset its state machine. The control logic 120 will further output signals to turn off power switches M1 and M2. This logic reset prevents any indeterministic state when switch over from BOOST to BUCK mode. In BUCK mode, Error Amplifier 119 regulates the system voltage by monitoring V_{FB} through sw4 connection. When V_{FB} is lower than the V_{REF}, the Error amplifier 119 output will change its logic state and causes the Ton generator 118 to trigger a Ton logic pulse width via control logic 120. The high-side power switch M1 will turn on and discharges the storage capacitor 105 C_{VSTG} back to V_{OUT} through inductor 106. High-side power switch M1 remains turned on until the end of Ton pulse width. At the end of Ton pulse, high-side power switch M1 is turned off while low-side power switch M2 is turned on after some dead time. The inductor current will continue to flow from the ground to V_{OUT}. Each time V_{FB} goes below V_{REF}, the above BUCK discharging operation is repeated. The operation of the synchronous BUCK discharging is not only limited to discontinuous conduction mode; the inductor current is discharged to zero before next cycle, it could also operate in continuous conduction mode. During BUCK mode operation, V_{OUT} is regulated to a voltage level defined as:

V_{OUT}=V_{REF}×(R1+R2)/R2

The BUCK operation continues until the voltage at storage capacitor 105 C_{VSTG}, is depleted to a minimum voltage supply the system can function.

The third embodiment in FIG. 6 and FIG. 7 can also include a protection circuit 122 that monitors the output voltage such as V_{FB} or V_{FB}_{_{—}}_{STG}. In the event of any failure such as short circuit or over voltage, the state machine can be reset to prevent the system from switching under abnormal conditions, and is applicable under both BUCK and BOOST operations.

What is claimed is:

1. A power failure prevention system comprising:
a voltage input terminal;
a voltage output terminal;
a charge-pump controller, serving as a charge pump under normal conditions, adapted to stop operation when a supply voltage level at the voltage input terminal drops below a predetermined level;
a switch adapted to control the electrical connection between said voltage input terminal and said voltage output terminal, wherein the switch closes under normal conditions and opens when the supply voltage level drops below a predetermined level;
a charge storage capacitor coupled to said charge pump controller and a dump controller;
an input supply capacitor coupled to said voltage input terminal;
an output capacitor coupled to said voltage output terminal;
a pump capacitor coupled to said charge pump controller, said pump capacitor and said charge pump controller taken together serving as a charge pump to generate a voltage up to two times the voltage level at said voltage input terminal, across said charge storage capacitor; and
said dump controller coupled to said voltage output terminal and adapted to direct the energy from said charge storage capacitor to said voltage output terminal, when the voltage level at the voltage input terminal drops below a predetermined level, thereby maintaining the voltage level at the voltage output terminal to substantially equal to an initial voltage level at said voltage input terminal.

2. The apparatus according to claim 1, wherein said charge storage capacitor comprises a plurality of capacitors adapted to generate a voltage which is more than two times the voltage level at said voltage input terminal, across said charge storage capacitor.

3. The apparatus according to claim 1, wherein said dump controller is a low drop-out linear regulator.

4. The apparatus according to claim 1, wherein said dump controller is a buck controller.

5. The apparatus according to claim 1, wherein said dump controller comprises:
an error amplifier having a first input terminal, a second input terminal, a third input terminal, a fourth input terminal and a first output terminal, wherein said first input terminal of said error amplifier is coupled to a reference voltage, and wherein said third input terminal of said error amplifier is coupled to the output terminal of said charge-pump controller;
a driver having a first input terminal, a second input terminal, a third input terminal and an output terminal, wherein said first input terminal of said driver is coupled to said first output terminal of said error amplifier, and wherein said second input terminal of said driver is coupled to said output terminal of said charge-pump controller;
an output MOS having a first passive electrode, a second passive electrode, and a control electrode, wherein said first passive electrode of said output MOS is coupled to said output terminal of said charge-pump controller, and wherein said second passive terminal of said output MOS is coupled to said voltage output terminal, and wherein said control electrode is coupled to said output terminal of said driver;
a feedback and compensation block having an input terminal and an output terminal, wherein said input terminal of said feedback and compensation block is coupled to said second passive terminal of said output MOS, and wherein said output terminal of said feedback and compensation block is coupled to said second input terminal of said error amplifier; and
a PVIN detector having an input terminal, a first output terminal and a second output terminal, wherein said input terminal of said PVIN detector is coupled to said voltage input terminal, and wherein said first output terminal of said PVIN detector is coupled to said fourth input terminal of said error amplifier, and wherein said second input terminal of said PVIN detector is coupled to said third input terminal of said driver.

6. The apparatus according to claim 5, wherein said reference voltage is internally generated.

7. A power failure prevention system comprising:
a voltage input terminal;
a voltage output terminal;
a boost controller adapted to store and charge a charge storage capacitor under normal conditions, and adapted to stop operation when a supply voltage level at the voltage input terminal drops below a predetermined level;
a switch adapted to control the electrical connection between a voltage input terminal and a voltage output terminal, wherein the switch closes under normal conditions and opens when the supply voltage level drops below a predetermined level;
a charge storage capacitor coupled to said boost controller and a buck controller;
an input supply capacitor coupled to said voltage input terminal;
an output capacitor coupled to said voltage output terminal;
a boost inductor coupled to said boost controller, said boost inductor and said boost controller taken together adapted to charge said charge storage capacitor to a level higher than the voltage level at said voltage input terminal;
a buck inductor coupled to said buck controller and a voltage output dump controller; and
a buck controller, cooperating with said buck inductor, adapted to generate an output at said voltage output terminal, when the voltage level at the voltage input terminal drops below a predetermined level, thereby maintaining the voltage level at the voltage output terminal to substantially equal to an initial voltage level at said voltage input terminal.

8. The apparatus according to claim 7, wherein said charge storage capacitor comprises a plurality of capacitors.

9. The apparatus according to claim 7, wherein said boost controller is a dc switching converter.

10. The apparatus according to claim 7, wherein said boost controller comprises:
an error amplifier having a first input terminal, a second input terminal and an output terminal, wherein said first input terminal of said error amplifier is coupled to a reference voltage;
a modulator having an input terminal and an output terminal, wherein said input terminal of said modulator is coupled to said output terminal of said error amplifier;
a driver having a first input terminal, a second input terminal and an output terminal, wherein said first input terminal of said driver is coupled to said voltage input terminal, and wherein said second input terminal of said driver is coupled to said output terminal of said modulator;
a feedback block having an input terminal and an output terminal, wherein said output terminal is coupled to said second input terminal of said error amplifier;
a low side output MOS having a first passive terminal, a second passive terminal and a control terminal, wherein said first passive terminal of said low side output MOS is coupled to said boost inductor, and wherein said second passive terminal of said low side output MOS is coupled to a ground level, and wherein said control terminal of said low side output MOS is coupled to said output terminal of said driver; and
an output diode, having an input terminal and an output terminal, wherein said input terminal of said output diode is coupled to said first passive terminal of said low side output MOS, and wherein said output terminal of said output diode is coupled to said input terminal of said feedback block.

11. The apparatus according to claim 10, wherein said reference voltage is internally generated.

12. A power failure prevention system comprising:
a boost-buck controller adapted to operate in a boost DC-DC converter mode serving to store and charge a charge storage capacitor under normal conditions, and adapted to operate in a buck DC-DC converter mode to direct the energy stored in said charge storage capacitor to an output terminal when a supply voltage level at a voltage input terminal drops below a predetermined level;
a switch adapted to control the electrical connection between said voltage input terminal and a voltage output terminal, wherein the switch closes under normal conditions and opens when the supply voltage level drops below a predetermined level;
a charge storage capacitor coupled to said boost-buck controller;
an input supply capacitor coupled to said supply voltage source;
an output capacitor coupled to said voltage output terminal; and
an output inductor coupled to said boost-buck controller;

13. The apparatus according to claim 12, wherein said charge storage capacitor comprises a plurality of capacitors.

14. The apparatus according to claim 12, wherein said boost-buck controller is a buck-boost DC-DC controller system.

15. The apparatus according to claim 14, wherein said buck-boost DC-DC controller system further comprises:
a feedback block having a first input terminal, a second input terminal, a first output terminal and a second output terminal, wherein said first input terminal of said feedback block is coupled to said voltage input terminal, and wherein said second input terminal is coupled to said charge storage capacitor;
a buck-boost DC-DC controller circuit; and
a power switch block, comprising:
a first power switch having a first passive terminal, a second passive terminal and a control terminal, wherein said first passive terminal of said first power switch is coupled to said feedback block, and wherein said second passive terminal is coupled to said output inductor; and
a second power switch having a first passive terminal, a second passive terminal and a control terminal, wherein said first passive terminal of said second power switch is coupled to said second passive terminal of said first power switch, wherein said second passive terminal of said second power switch is coupled to ground.

16. The apparatus according to claim 15, wherein said feedback block comprises of resistive voltage dividers.
